(19) United States
(12) Patent Application Publication
(10) Pub. No.: US 2007/0083322 A1
(43) Pub. Date: Apr. 12, 2007

(54) Freeway optimization program

(76) Inventor: Jonathan Hendrik Van Ee, San Jose, CA (US)

Correspondence Address: Jonathan Hendrik Van Ee;#74, 1055 North Capitol Ave., San Jose, CA, 95133, US

(21) Appl. No.: 11/247,726

(22) Filed: Oct. 11, 2005

(51) Int. Cl. G08G 1/00

(52) U.S. Cl. 701/117

(57) ABSTRACT

This invention enables freeways to carry the maximum amount of traffic they can safely carry during times of heavy use of the freeway system. The invention would maximize freeway capacity by restricting the inflows of traffic and facilitating the exits from the freeway. Freeway inflows would be restricted by extensive use of metering lights and restrictions on speeds on the freeway itself. Freeway exits would be facilitated by changing traffic lights, stop signs, and anything else that restricts exits from a freeway, to allow for the free flow of traffic off a freeway. An optimized freeway system would shorten commutes, lessen consumption of gas, lower pollution, and lessen the need to build or expand freeways. Thus, it would save several billions of dollars every year.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This invention arises out of the current state of freeways, in which vehicles are regulated by rudimentary means. For example, there is ordinarily one speed limit for a freeway. That speed limit is the same regardless off traffic load or road conditions. Highway patrol do not necessarily enforce that speed limit. In addition, access to freeways is generally allowed without taking into account the optimal level of traffic a freeway can carry. The shortcomings of these rudimentary controls allow for freeways to accumulate more traffic than they can optimally carry. Congestion results, bringing traffic to a standstill. This invention optimizes freeways so that, during peak traffic hours, traffic moves through freeways at the highest volumes possible. Thus, traffic will not sit still on a freeway during precisely the time that society most needs a free flowing freeway.

Metering lights are crude ways to implement a part of what this invention does, which is to optimize the operation of freeways. Road sensors that sense the level of freeway traffic are also a related technology. Radar guns, and an electronic system that automatically tickets vehicles that break a speed limit are also related technologies. Finally, sensors that detect when a vehicle goes through a toll booth and automatically charges the vehicle the toll amount is also a related technology. This invention builds on those technologies to achieve drastically better results.

### BRIEF SUMMARY OF THE INVENTION

This invention would drastically minimize congestion on freeways by maximizing freeway capacity. It would maximize freeway capacity by restricting the inflows of traffic and facilitating the exits from the freeway. Thus, it would ensure that traffic on the freeway would flow at the optimal level, which is the level at which it can safely carry the most traffic. This invention would thereby shorten commutes, lessen consumption of gas, lower pollution, and lessen the need to build or expand freeways. Thus, it would save several billions of dollars every year.

### BRIEF DESCRIPTION OF SEVERAL VIEWS OF THE DRAWING

Not applicable.

### DETAILED DESCRIPTION OF THE INVENTION

I. The Problem

Currently, cars proceed down a freeway until the freeway gets overcrowded. When a freeway is overcrowded, cars come to a standstill. When cars are at a standstill, the freeway is not carrying traffic at its maximum capacity. This is an important problem because cars come to a standstill during rush hours, which is precisely when it is important for the freeway to operate at an optimum level.

In general, the current system at all times treats cars as largely unrestricted individual units. During rush hour, or when a freeway system is otherwise busy, it is best to think of how vehicles operate within the entire road system. That is because cars as a group (not as individual cars) bunch up and cause traffic delays.

One way to think of a freeway during rush hour is to picture a train. Cars on a busy freeway act like a train. During rush hour they need to come to a stop slowly, like a train (cars must come to a stop slowly because that is safer than stopping as fast as an individual car is able to stop). Conversely, like trains, a group of cars cannot start right away when the group is stopped. It takes them a little time to get moving.

II. The Solution

Traffic rules and freeways should be changed to take into account the fact that flows of traffic on busy freeways operate like trains. One of the most important rules about regulating such flows is minimizing the amount of stopping and starting that vehicles on the road must perform.

A freeway must not have more cars than it can carry at an optimum level. Thus, when the car load on a stretch of freeway reaches the optimum level, more cars should not be allowed on that stretch of freeway. Allowing more cars on the freeway will contribute congestion, delay, etc., because the cars will slow to a standstill.

A freeway can operate optimally if its access points are restricted and its exit points freely allow traffic to exit.

A. Access Points

Cars enter onto a stretch of freeway from two places: (1) on-ramps to the freeway; and (2) the part of the freeway immediately before the stretch of freeway. Both of these entrance ways must be restricted to keep the capacity of the freeway from going beyond its optimum level.

1. On-Ramps

Metering lights currently are one way access to the freeway is impeded at on ramps. However, they are simple mechanisms that continue to allow cars on to a freeway even after the freeway has exceeded the optimum level of vehicles it can carry. Thus, current metering lights will not keep a freeway from exceeding its capacity and having cars come to a standstill.

Metering lights must adjust the number of cars they allow based on the level of traffic on the freeway. If the freeway is approaching its optimum capacity level, then metering lights should allow less vehicles on to the freeway. That way, the metering lights will not allow the freeway to get overcrowded.

2. The Part of the Freeway Immediately Before the Stretch of Freeway

Cars traveling on the freeway from far away distances may also become concentrated on a portion of the freeway and cause traffic to come to a standstill. Thus, the flow of the freeway itself must be controlled so that the optimum capacity of the freeway is not exceeded on any particular stretch of freeway. The flow of the freeway must be controlled by making the freeway itself slow down in portions preceding areas of the freeway that will become congested absent such control.

The cars on the freeway and the cars attempting to enter the freeway from on-ramps must be slowed down to an equal degree to allow both of them equal access to the freeway. This is basically the same level of relative access they would have without the freeway optimization program in place. As things stand now, vehicles on the freeways and vehicles entering the freeway via an on ramp have essentially the same access—although metering lights do impede access of on ramps to some degree. A policy decision could be made to allow one of these two access points more access than the other.

B. Exit Points

With an optimized freeway, portions of road that follow the optimized portion of the freeway would also probably have to be optimized because then they could become congested. For example, with more cars coming down the freeway, an intersection at an off ramp could become congested and back up into the freeway. Thus, an optimized freeway could have the unintended effect of moving points of congestion further down the freeway or road system. For this reason, it is important to optimize the road system until cars and trucks are completely out of the way to allow for traffic to move optimally.

There are a number of ways to do this.

An intersection off a freeway with a stop sign might get congested if suddenly hundreds of cars come to the intersection off an optimized freeway. In such a circumstance, it may be a good idea to place a stop light at the intersection.

If an intersection right on an off ramp already has a stop light, that intersection may also get congested by all the cars approaching it. This can be adjusted by having the stoplight have different timing when the freeway is busy. When more cars are coming off the freeway, the light could give them more time to enter the intersection. Other lights down the streets from that intersection may also have to adjust and also allow more time for traffic exiting the freeway to go through.

During rush hour lights on roads that take cars off the freeway should be synchronized so that cars that go through one light do not then have to wait for the next light. Lights that ordinarily change when they sense the presence of a car should be overridden when a string (or “train”) of cars is coming off the freeway (or is allowed to come through the intersection in one shot).

Lengthy off ramps can trigger a stoplight to change when the off ramp gets full. This will ease congestion in the freeway and lessen the danger of accidents for cars standing still on the freeway waiting to get to an off ramp.

While it will be less convenient for drivers on side streets who have to wait longer at lights because of traffic exiting the freeway, that loss of convenience will be offset by the higher value received by the larger volume of commuting traffic during rush hour. Drivers on side streets can also adapt by taking other streets or by running errands at times other than rush hour. For commuting drivers, they often have little choice but to travel on a certain freeway (or set of freeways) and do not have as much flexibility on when to travel. They simply have to be at work at certain times.

III. How to Practically Implement the Solution

This system has a number of key components outlined below.

A. Road Sensors

Sensors throughout the entire freeway system tell a computer how fast traffic is traveling at all points on the freeways and on all relevant neighboring roads. Sensors can tell not just how fast the traffic is moving at all points, but what kind of traffic exists. Thus, the system will be able to tell whether there are a lot of trucks and buses, cars, motorcycles, or other kinds of vehicles frequented in an area.

The data from those sensors will be fed to a computer that will figure out the optimal speeds for the freeway based on the density of traffic, the kind of vehicles (i.e., trucks or cars), weather conditions, and road conditions.

B. Speed Limit Indicators

Throughout all parts of a freeway, spaced at intervals of about ¼ of a mile, there will be electronic signs that establish the speed limit for the freeway. If traffic must be slowed, the speed limit will decline. These signs can establish speed limits that are different for certain lanes. Trucks can be restricted to certain lanes, which would have slower speed limits than other lanes.

C. Computer Program

A computer would take all information from the sensors and output appropriate speed limits and other information to the speed limit indicators. The computer could also output information to a website that would show at a glance what traffic conditions are. That website feed could also be broadcast to GPS receivers, so that people in their cars could see how traffic is flowing, what the speed limits are, etc. Finally, the computer could transmit an electronic traffic report over a radio station to guide people who do not have GPS.

D. Traffic Guidance System

Drivers could have in their car a traffic guidance system that tells drivers important things about the transportation system. The above computer program would send information to these guidance systems in each vehicle.

The computer program would generate a map that indicates levels of traffic. Busy traffic areas would be in red, sparse traffic would be indicated in green, and all levels in between would be indicated with colors that are a blend of red and green. The guidance system could indicate what the speed limit is. It could also warn the vehicle of the fact that the system believes the car is breaking a speed limit. The guidance system could give the driver a warning before actually giving the driver a ticket.

The guidance system could also be a channel for advertisements, could be a vehicle for surfing the internet, and could advise drivers of good deals as they drive past commercial establishments offering those deals. If a vehicle was stolen, the guidance system could be used to track the stolen vehicle.

The guidance system could also suggest routes in light of traffic patterns. In an advanced stage of the program, the system could process where all the people on the road system want to go, optimize the freeway accordingly, and suggest routes to drivers in light of those factors.

E. Implementation in Phases

This solution can be implemented initially on simpler stretches of freeway that do not have many intersections. For example, it could be implemented on the east bound side of 580 from the 680 junction to the I 5 junction. There, during peak traffic periods, the freeway must simply carry traffic at optimal levels from one point of the freeway to the other. There is a minimal amount of traffic getting on to the freeway via on-ramps, so that is not a complication factor. Most of the traffic is from 580 itself and from 680.

IV. Other Matters

A. Accidents

The system should be able to sense when an accident occurs because of the pattern of traffic piling up at a certain point on the freeway. When the system senses an accident it should automatically notify the police, fire and ambulance services. The optimal speed for the freeway will drop, depending on how many lanes of traffic are taken up by the accident. The system will steer traffic out of blocked lanes and into clear lanes at safe speeds. Police and other emergency personnel will be able to adjust the speed of the traffic allowed by the system if the accident is especially severe and requires slower speeds of traffic.

B. Unusual Events

The system must take into account construction, landslides, or traffic jams caused by drivers simply observing something unusual by the roadside. Thus, if a landslide wipes out a lane of traffic and becomes something people will stare at and thereby slow down traffic, the system must find the optimal speed for such an occurrence and indicate to drivers that they must proceed at that speed.

C. Optimal Speed

The optimal speed for different parts of a freeway will be different at different points. In an area where lots of merging occurs, the optimal speed will be lower than in a straight stretch of freeway. Similarly, curvy or mountainous stretches of freeway will also have lower optimal speeds of traffic. In addition, optimal speed will vary depending on road conditions, such as if it is sunny, snowy, rainy, dark, light, icy, etc. Finally, the kind of vehicles traveling on the road will impact the optimal speed. Large trucks will probably cause the optimal speed to be lower, especially if they are merging or climbing a hill.

The optimal speed can be different for different lanes too. For example, a faster lane that trucks are not permitted to operate in would have a higher optimal speed than a lane with lots of trucks merging into traffic.

The program that optimizes the freeway must be able to sense the presence of all these factors, take them into account, and adjust the optimal speed as necessary.

Optimal speed may change as cars become more sophisticated, the traffic composition changes (for example, more busses may use the road over time), etc.

Enforcing the optimal speed will require more sophisticated enforcement procedures than those that currently are used. The system could take a picture of an offending car's license plate and send them a ticket. People would get a ticket for going either too slow or too fast. The system would sense who is slowing down traffic, and dispatch a ticket to that car. If a car slows traffic, the speed limit would have to be lowered, to compensate for the one car that is going too slow. All other cars that get slowed down because of a slower car that breaks the lower speed limit would not get a ticket, and the system would be able to differentiate the two kinds of cars.

Vehicles should not be allowed to travel at a speed that is lower than the minimum. The minimum speed limit will be set at a certain number of miles per hour (about 10 miles per hour) less than the maximum speed limit. This will increase the flow of traffic and safety. The minimum speed will not apply however when there is an accident or an unusual occurrence. It will also adjust lower during rain, nighttime, and other adverse occurrences.

D. Optimizing with Road Construction

In some instances, freeways may not be built in a manner that facilitates optimization. For example, if a fast moving freeway has an exit ramp onto another busy freeway whose optimal speed is lower, then vehicles will have to slow significantly to get from the fast freeway to the slower one. However, if there is not a long off ramp, cars may get backed up in the fast moving freeway, thereby hindering traffic. Thus, it may be helpful to have longer on or off ramps under certain circumstances.

E. Restrictions on Vehicle Use

Very wide vehicles, vehicles with unusual dimensions that affect their speed and the speed of traffic around them, and vehicles that cannot reach the minimum speed limit should not be allowed on the freeway during peak hours of operation.

Matters that are Not Part of this Invention

This invention is not an invention of technology that detects vehicle speed, metering light technology, technology that detects how much traffic is on a freeway or a system for automatically ticketing drivers.

I claim the freeway optimization program will:

1) drastically minimize congestion on freeways by maximizing freeway capacity;

2) shorten commute times;

3) lessen consumption of gas;

4) lower pollution; and

5) lessen the need to build or expand freeways.
